(19) United States
(12) Patent Application Publication
(10) Pub. No.: US 2026/0318682 A1
(43) Pub. Date: Oct. 15, 2026

(54) METHOD FOR MEASURING THE DEVIATIONS OF A LONGITUDINAL AXIS OF A PROFILE FROM A STRAIGHT TARGET COURSE

(71) Applicant: MOST Technik GmbH, St. Konrad (AT)

(72) Inventor: Friedrich Moser, Scharnstein (AT)

(21) Appl. No.: 19/120,079

(22) PCT Filed: Sep. 4, 2023
(86) PCT No.: PCT/AT2023/060308

§ 371 Date: Apr. 10, 2025

(30) Foreign Application Priority Data
Nov. 14, 2022 (AT) A 50860/2022

(51) Int. Cl. G01B 21/20

(52) U.S. Cl. CPC G01B 21/20

(57) ABSTRACT

A method for measuring the deviations of a longitudinal axis of a profile from a straight set course has a measuring device for recording the positional coordinates of contour points of the profile. The deviations of the actual course from the straight set course are determined in an evaluation device from the positional coordinates of contour points of individual cross-sectional areas (Q). A reference line passing through two corresponding contour points in different cross-sectional areas is first determined, reference points being obtained in the individual cross-sectional areas as points of intersection of the reference line with the respective cross-sectional area. The position coordinates of the contour points corresponding to one another in the individual cross-sectional areas are then detected before the measuring operation is repeated after a rotational adjustment of the profile, which is mounted in two rotationally adjustable receiving means in a rotationally fixed but moment-free manner. The deviations from the straight set course of the profile are determined in the evaluation device from the positional coordinates, related to the reference points, of the contour points detected in at least two rotational positions of the profile.

### TECHNICAL FIELD

The invention relates to a method for measuring the deviations of a longitudinal axis of a profile from a straight set course, with a frame that records the profile and a measuring device provided in the frame for recording the positional coordinates of contour points of the profile, wherein the deviations of the actual course of the longitudinal axis of the profile from a straight set course are determined in an evaluation device from the positional coordinates of contour points, which are offset at an angle to one another, of individual cross-sectional areas distributed over the profile length.

### STATE OF THE ART

In order to measure the cross-section on the one hand and the deviation of the longitudinal axis from a straight set course of a profile on the other, it is known (DE 44 44 787 A1) to support the profile in receiving means of a frame, for example on a cross conveyor, roughly aligned and to measure it by means of a measuring device which is guided in the frame parallel to the longitudinal axis of the profile and has at least one measuring head that can be displaced by a cross slide or an articulated arm in a plane perpendicular to the longitudinal guide of the measuring device. The measuring data from the measuring head scanning the front side of the profile can be used to determine the profile cross-section in an evaluation device and to calculate the centre point of the cross-sectional area from the profile cross-section, in order to then measure, in successive measurement procedures in which the measuring device is moved along the profile, on the one hand, the horizontal distance of the profile from the path of the measuring head and, on the other hand, the height, so that the course of the profile longitudinal axis can be determined from this measurement data related to the profile length, in a three-dimensional coordinate system with the position coordinates in the horizontal and vertical direction and in the direction of the profile longitudinal axis. The disadvantage, however, is that the profile cross-section has to be determined and that the profile deformations caused by the profile support on a frame support are not recorded.

In order to consider the deformations of a profile caused by a support, it is also known (WO 2019/082134 A1) to support the profile to be examined in a stationary manner on several supports and to measure the bearing forces that occur either only due to the dead weight or an external additional force, so that, on the basis of pre-settable mechanical material properties, in particular the modulus of elasticity, and the profile cross-section, the deformations of the profile due to the support conditions over the profile length can be calculated and considered when determining the deviations of the actual course of the profile from the set course. Apart from the fact that the profile cross-section is determined in a complex manner by recording several contour points offset against each other at an angle in several cross-sectional areas distributed over the profile length, by means of a measuring device with corresponding measuring heads that are preferably moved one after the other along the profile from measuring plane to measuring plane, the set course of the profile must be calculated with the disadvantage that changing material properties over the length of the profile must be disregarded.

In another known measuring device (EP 3 093 611 A2), in which the cross-sectional position of a profile is detected in several measuring planes distributed over the profile length on the basis of a plurality of contour points in the individual measuring planes and the actual course of the profile axis is calculated from the coordinates of the cross-section centres calculated from these, the profile is supported on pivoted rockers to consider the deformations caused by gravity, which allow the bearing forces per rocker to be balanced, but disregard profile bending caused by gravity between the bearing points.

To check the straightness of a rolled profile, it is known (WO 2006/138220 A1) to arrange a measuring system downstream of the last pair of rollers, which has at least three imaging modules that are connected to an evaluation device and arranged at a mutual distance in the longitudinal direction of the profile, which respectively detect contour points of the rolled profile in a measuring plane containing a profile cross-section, in order to calculate the coordinates of the cross-sectional centre of gravity in the respective measuring plane on the basis of the coordinates of these contour points, which are referenced to a coordinate system, and the profile cross-section. If the centres of gravity of the entry and exit-side measuring planes of the measuring system are connected by a reference line, the difference between the centre of gravity coordinates in the intermediate measuring planes and the coordinates of the points of intersection of the reference line with the respective measuring plane can be evaluated as a measure of the deviation of the rolled profile from a straight set course between the entry and exit-side measuring planes. However, a disadvantage is that deformations caused by gravity cannot be detected.

### DESCRIPTION OF THE INVENTION

The invention is therefore based on the problem of providing a measuring method that can be used to quickly determine the deviations of a longitudinal axis of a profile from a straight set course with high accuracy, without knowledge of the profile cross-section and the mechanical material properties.

Based on a method of the type described at the beginning, the invention solves the problem by first defining a reference line passing through two corresponding contour points located in cross-sectional areas spaced apart from one another is first determined, reference points being obtained in the individual cross-sectional areas as points of intersection of the reference line with the respective cross-sectional area, that the position coordinates of the contour points lying on a common profile generating line are then recorded in the individual cross-sectional areas in a measuring operation before the measuring operation is repeated after a rotational adjustment of the profile, which is mounted in two rotationally adjustable receiving means in a rotationally fixed but torque-free manner, and that the deviations from the straight set course of the profile are determined in the evaluation device from the positional coordinates, which are referenced to the reference points, of the contour points detected in at least two rotational positions of the profile.

The invention is based on the finding that a reference line passes through two contour points of the profile, corresponding to one another in two cross-sectional areas arranged at a mutual distance, parallel to the straight set course of the longitudinal axis of the unloaded, moment-free profile. From the positional coordinates, referred to this reference line, of contour points that lie on a common profile generating line, i.e. on a connecting line of the corresponding contour points of successive cross-sectional areas, the deviation of the course of the profile generating line from a straight set course of this profile generating line parallel to the reference line can thus be determined in a specified rotational position of the profile in individual cross-sectional areas. Since the profile is mounted in two rotatable receiving means in a rotationally fixed but torque-free, the profile is loaded in the respective rotational position only by the weight moment, so that the measured deviation of the profile generating line from the straight set course depends, on the one hand, on the geometric deviation of the actual course of the unloaded profile from the set course and, on the other hand, on the weight-related bending course of the profile held torque-free in two receiving means. Due to the fact that at least two measuring operations are planned in different rotational positions of the profile, in which the actual course of a profile generating line is recorded in each case on the basis of the position coordinates of corresponding contour points in several cross-sectional areas, the deviations caused by the weight load can be eliminated from the position coordinates, recorded in different rotational positions of the profile, of the contour points lying on a profile generating line, so that the deviation of the longitudinal axis of the unloaded profile, not subjected to a weight moment, from the straight set course in the respective cross-sectional area can be determined from the positional coordinates of the contour points recorded in different rotational positions of the profile, without knowledge of the profile cross-section and the elastic properties of the profile.

It is comparatively easy to consider the elastic bending of a profile caused by the weight moment for profile cross-sections whose geometrical moments of inertia about the main axes are equal, because in this case all contour points of the cross-sectional areas move on circular paths when the profile rotates. Minor differences in the principal moments of inertia can be neglected despite the required measurement accuracy because of the comparatively small influence on the deviations of the orbit of the contour points from the circular shape.

If the profile cross-section has different principal moments of inertia, the different geometrical moments of inertia with respect to different axes are to be considered. By specifying the ratio of the geometrical moments of inertia with respect to the principal axes of the profile cross-section, the shape of the contour point path that deviates from the circular path due to the directionally dependent different geometrical moments of inertia can be determined during a profile rotation and used to calculate the deviation of the longitudinal axis of the bending moment-free profile from the straight set course. However, such a procedure is not necessary if the measurements are taken at coordinated angles of rotation. This applies in particular to the recording of the position coordinates of the contour points in two rotational positions of the profile that are offset by 180° relative to each other, because in these rotational positions the weight-related bending of the profile is the same and can therefore be ignored. If the position coordinates of the contour points cannot be recorded after the profile has been rotated by 180° because these contour points move out of the detection range of the measuring device used when the profile is rotated in this way, the position coordinates of the contour points can also be recorded in three rotational positions of the profile, each differing by 45°.

The position coordinates of contour points in certain cross-sectional areas can be recorded by measuring heads distributed along the profile. However, simpler structural conditions arise if the measuring device has at least one measuring head that can be moved along the profile, which is moved from cross-sectional area to cross-sectional area during each measuring operation and successively records the positional coordinates of the corresponding contour points in the individual cross-sectional areas.

### BRIEF DESCRIPTION OF THE INVENTION

The drawing is used to further explain the method according to the invention.

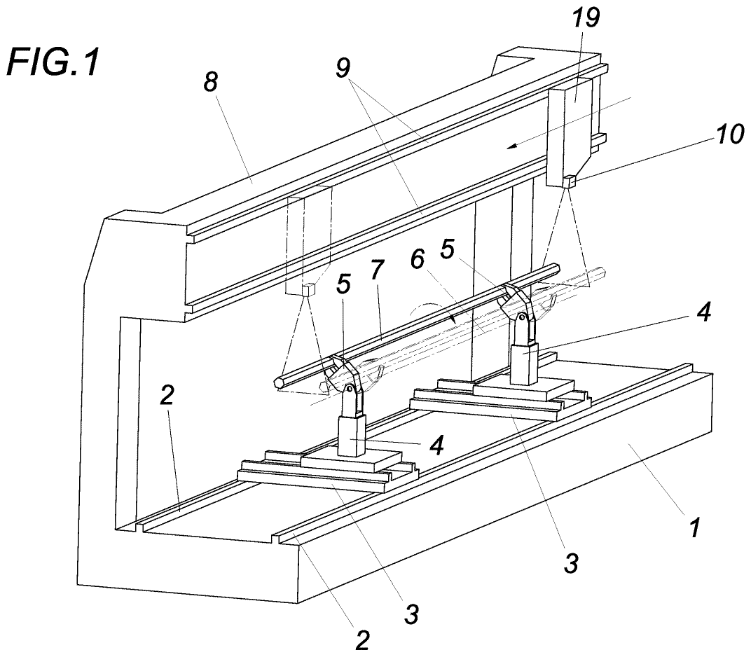

FIG. 1 shows a device for implementing the method according to the invention in a simplified diagram,

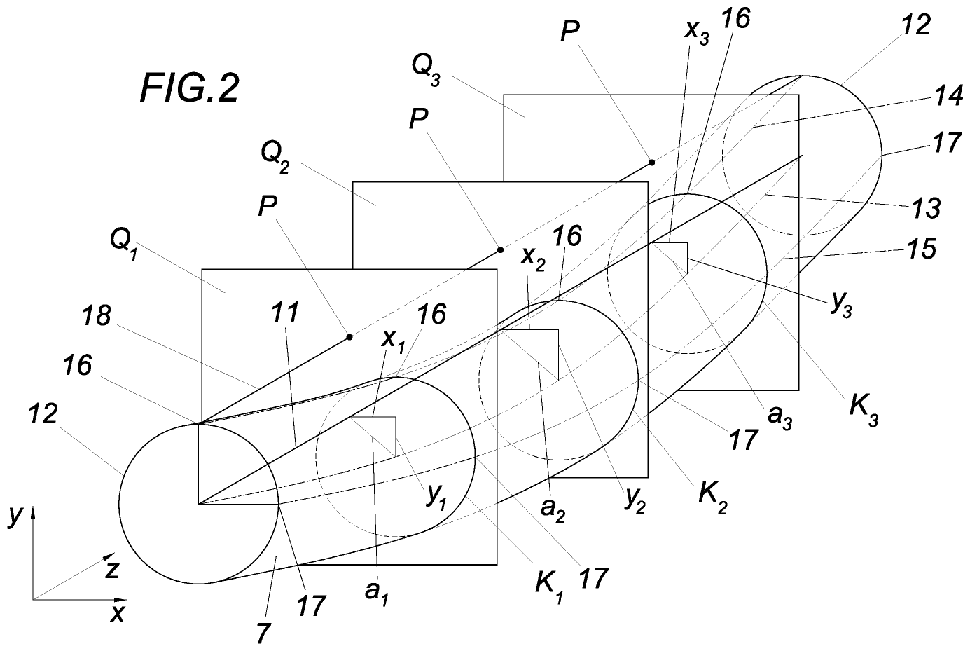

FIG. 2 shows the course of a profile with a circular cross-section, which is mounted in a torque-free manner in two receiving means, in a rotary position in a schematic diagram,

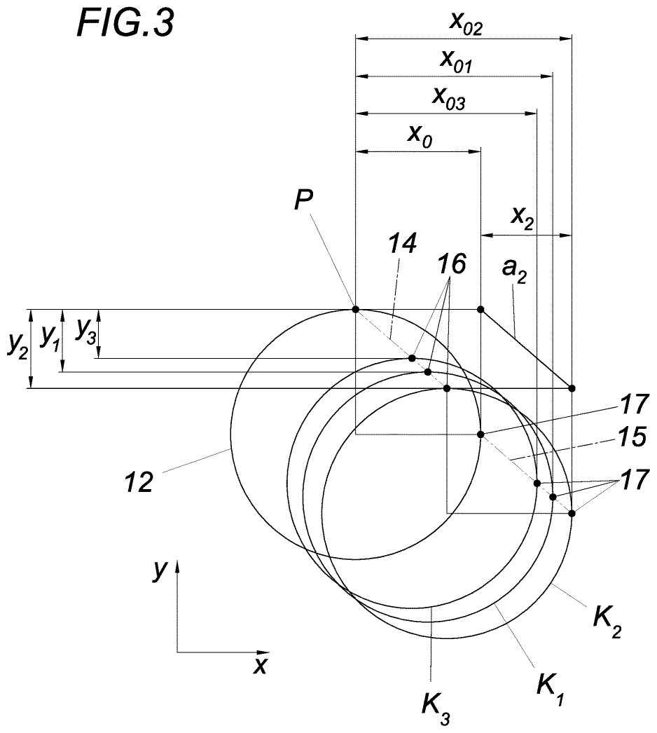

FIG. 3 shows the course of the profile of FIG. 2 on the basis of the cross-sections drawn in FIG. 2 in a front view on a larger scale,

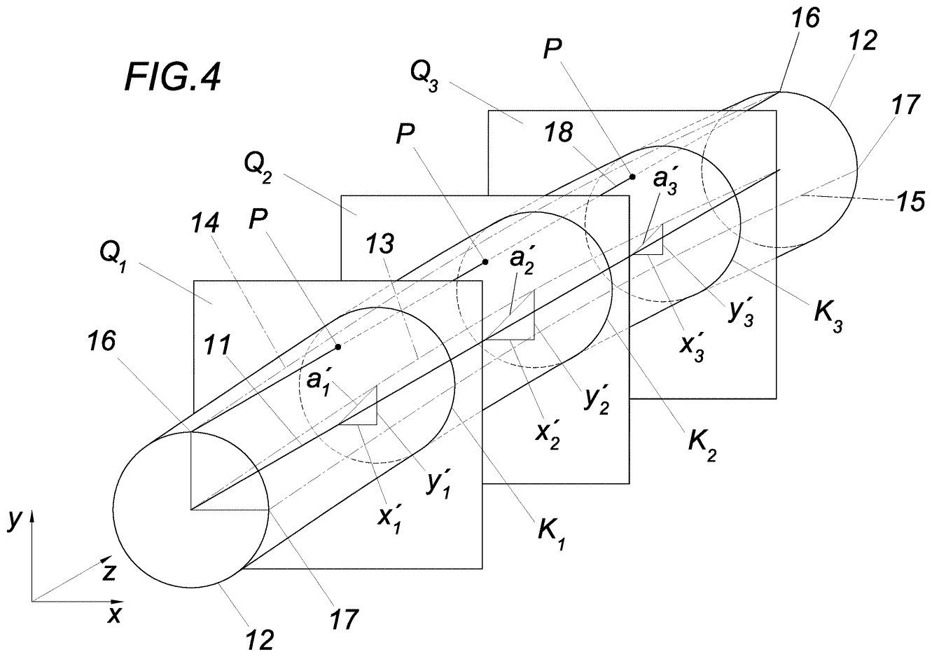

FIG. 4 shows a representation of the profile rotated by 90° corresponding to FIG. 2 and

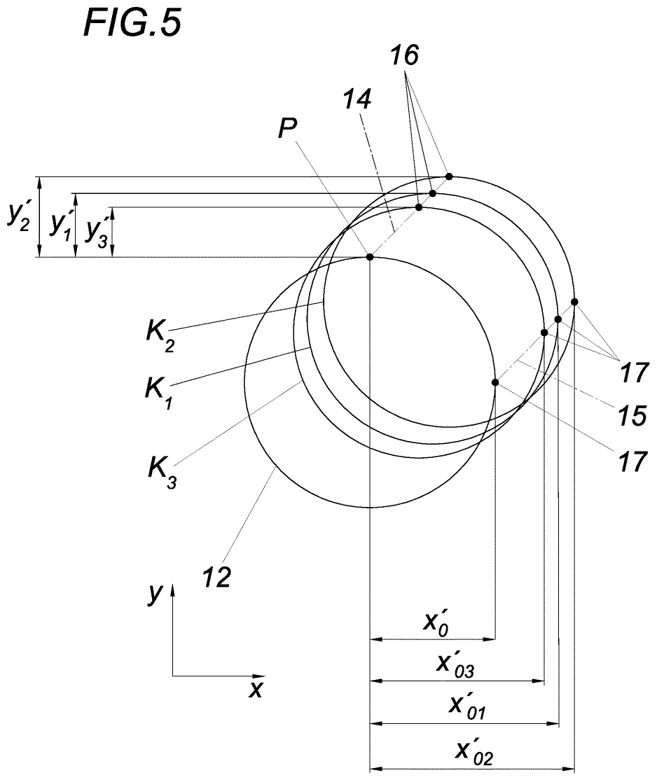

FIG. 5 shows the profile in the rotated position according to FIG. 4 in a representation corresponding to FIG. 3.

### WAYS OF IMPLEMENTING THE INVENTION

The device according to FIG. 1 has a frame 1 with two carriages 3 that can be moved on guide rails 2, on which height-adjustable supports 4 are mounted for one receiving means 5 each. The profile 7 to be measured is mounted in each of these receiving means 5, which are rotationally adjustable about a common axis 6 parallel to the guide rails 2, in a rotationally fixed but torque-free manner, so that the profile 7 is loaded only by its own weight and therefore, due to its elastic properties, bends exclusively under its own weight between the receiving means 5, avoiding any clamping moments.

The frame 1 is provided above the guide rails 2 with a longitudinal support 8, which forms a guide 9 parallel to the guide rails 2 for at least one measuring head 10, which can thus be displaced along the profile 7 held in the receiving means 5, in order to detect the positional coordinates of contour points of the profile 7 corresponding to one another in individual cross-sectional areas. For this purpose, the measuring head 10 can also advantageously be displaced along coordinate axes spanning the cross-sectional areas, which, however, is not shown for reasons of clarity.

The corresponding contour points lie on a profile generating line and can be easily measured in particular if the profile generating line is determined by a longitudinal edge of the profile 7 or by the course of the profile contours in two different measuring directions, for example in the vertical and horizontal direction, as explained in more detail below.

In FIG. 2, a profile 7 is shown for the purpose of simplicity with a circular cross-section in a course deviating from the straight set course, as it arises in the drawn rotational position in the case of a moment-free bearing in the two receiving means 5 due to the geometric deviation from the set course and due to the weight-related bending. The load-free, geometric set course 11 of the profile 7 is a straight line connecting the centres of the two front circles 12 of the profile 7. The actual course 13 of the profile axis, indicated by a dashed line, deviates from the set course 11 to a greater extent for the purposes of better understanding. For illustrative purposes, this deviation in cross-sectional areas Q₁, Q₂ and Q₃ is shown using a Cartesian coordinate system x, y, z. Accordingly, the deviation a₁ of the actual course 13 from the set course 11 in the cross-sectional area Q₁ is determined by the coordinates x₁ and y₁. In the other two cross-sectional areas Q₂ and Q_{3,} the deviations a₂ and a₃ result analogously from the coordinates x₂, y₂ and x₃, y₃.

Since the position coordinates xᵢ, yᵢ of the centres of the cross-section circles Kᵢ cannot be determined directly, the position coordinates of contour points of the profile 7 are determined along a profile generating line by means of the measuring head 10. A profile generating line is understood to be a line connecting the corresponding contour points of successive profile cross-sections. Such profile generating lines can advantageously be predetermined by profile edges that are easy to measure, by the distance of a profile surface or by the course of a profile contour. In accordance with FIGS. 2 to 5, the contour generating lines resulting in the direction of the coordinate axes x and y are used as profile generating lines by example. Accordingly, a profile generating line 14 indicated by a dashed-dotted line results as a profile contour in the direction of the x-axis for recording the position coordinates in the y-direction, and a profile generating line 15 as a profile contour in the direction of the y-axis for recording the position coordinates in the x-direction. Since it can be assumed that the profile 7 is largely free of torsion, this means that the profile generating line 14 connects the corresponding contour points 16, which lie on a radius, parallel to the y-axis, of the respective circular cross-section, while the profile generating line 15 connects the contour points 17 of the individual circular cross sections Kᵢ, which are determined by a radius parallel to the x-axis, with the two profile generating lines 14, 15 being parallel to each other and to the actual course 13 of the profile longitudinal axis.

A reference line 18 is specified to determine the actual course of the longitudinal profile axis. This reference line 18 connects two corresponding contour points of the profile 7 in two cross-sectional surfaces at a distance from each other. In the illustrated example, the contour points 16 of the two front circles 12 are used for the purpose of simplicity to determine the reference line 18, which corresponds to the straight set course of the profile generating lines passing through these contour points and thus runs parallel to the set course 11 of the profile longitudinal axis. With the determination of a reference line 18, reference points P arise in the individual cross-section areas Qᵢ as the points of intersection of the reference line 18 with the respective cross-section area Qᵢ, so that the position coordinates of the contour points 16, 17 can be related to these reference points P with respect to the x- and y-axis.

This means, for example, according to FIG. 3 for contour point 16 of the circular cross-section K₂, a distance x₀₂ in the x-direction and a distance y₂ in the y-direction relative to the reference point P. Since, unlike contour point 16, which coincides with the reference point P in the front circle 12, contour point 17 of the front circle 12 has a distance x₀ from the reference point P, this distance must be considered when determining the positional difference between the corresponding contour points 17 of the front circle 12 and the circular cross-section K₂, by calculating the difference of the position coordinates for the distance x₂ of the contour points 17 of the front circle 12 and the circular cross-section K₂, so that x₂=x₀₂−x₀. The distance a₂ defined by the coordinates x₂, y₂ thus corresponds to the deviation of the actual course 13 of the profile axis from the straight set course 11 in the cross-sectional area Q₂. Similarly, the coordinates x₁=x₀₁−x₀, y₁ indicate the positional deviation a₁ and the positional coordinates x₃=x₀₃−x₀, y₃ indicate the positional deviation a₃ of the actual course 13 of the profile axis from the set course 11 in the cross-sectional areas Q₁ and Q₃.

The coordinates of the reference point P and the contour points 16, 17 in the individual cross-sectional areas are recorded by means of the measuring head 10 of a measuring device, so that the measuring device records position coordinates that do not refer to the reference line 18 but to the position of the measuring head 10 in relation to the profile 7 in the respective cross-sectional area. The difference between the position coordinates in the x and y directions detected by the measuring head 10 on the one hand for the reference line 18 and on the other hand for the contour points 16, 17 gives the coordinates xi, yi in the cross-sectional area Qi, with errors in the path of the measuring head 10 being cancelled out due to the calculation of the difference.

After recording the actual course 13 of the longitudinal profile axis in relation to a straight set course 11 in a rotational position of the profile 7, the profile 7 is rotated by an angular step with respect to its longitudinal axis in order to repeat the described measuring operation in the new rotational position of the profile 7. In FIGS. 4 and 5, the profile 7 from FIG. 2 is shown rotated by 90°. The displacements of the cross-section circles K₁, K₂ and K₃ in the cross-section areas Q₁, Q₂ and Q₃ result, on the one hand, from the deviation of the profile longitudinal axis from the straight set course and, on the other hand, from the weight-related bending moment.

According to FIGS. 4 and 5, the coordinates of the deviations a′ of the actual course of the profile longitudinal axis result from the straight set course in the individual cross-sectional areas Q₁, Q₂ and Q₃ to a′₁ (x′₁=x′₀₁−x′₀, y₁), a′₂ (x′₂=x′₀₂−x′₀, y₂) and a′₃ (x′₃=x′₀₃−x′₀, y₃).

The difference in size between the deviations aᵢ and a′ᵢ in the individual cross-sectional areas Qᵢ when recording the actual course 13 of the profile longitudinal axis is based on the weight-related bending moment load of the profile 7, which is kept free of torque in the different rotational positions. For profile cross-sections with identical geometrical moments of inertia with respect to the main axes, the weight-related bending is the same in every rotational position of the profile, so that the weight-related portion of the deviations a of the actual courses 13 from the straight set course 11 in the two rotational positions can be eliminated by calculation from the measured data recorded in at least two different rotational positions of the profile 7.

This means that the actual geometric deviation of the unloaded profile 7 can be determined in the individual cross-sectional areas Qi without knowing the profile cross-section or the mechanical properties of the profile 7.

In the case of profile cross-sections with different principal moments of inertia, the contour points 16, 17 do not move in a circular path when the profile 7 is rotated because different moments of inertia arise in different directions, which causes different bending due to weight. In order to avoid having to rely on knowledge of the principal moments of inertia or their ratio and thus on the cross-sectional shape for such profiles 7, the position coordinates of the contour points 16, 17 of the profile 7 in the various cross-sectional areas Qi can be recorded in rotational positions of the profile 7, which differ by certain selected rotation angles, because the deformation of the profiles 7 caused by weight can be eliminated by calculation even with a corresponding mutual reference of the positional coordinates of the contour points, if these positional coordinates are recorded in rotational positions of the profile 7 that differ by specific angular steps. Particularly simple measurement conditions arise in this context with rotational positions offset by 180° in relation to each other, which are characterized by a corresponding weight-related deformation of the profiles 7, independently of the ratio of the principal moments of inertia.

With conventional measuring devices, the shifting of contour points 16, 17 when the profile is turned by 180° can result in the contour points 16, 17 to be detected being moved out of the detection range of the measuring device when the profile is turned. In such a case, the rotation steps between the individual rotations of the profile 7 can be 45°, although this requires the recording of the positional coordinates in three rotational positions, each differing from one another by 45°, in order to be able to mathematically eliminate the deformation due to its own weight.

The evaluation devices can be provided separately from the device. According to FIG. 1, however, the evaluation device 19 is combined with the measuring head 10 to form a single unit as part of the measuring device.

If the position coordinates of contour points 16, 17 along contour lines of profile 7, each assigned to a coordinate axis, are not recorded, but, for example, the course of a profile edge is measured as a profile generating line, then the contour points determined by the profile edge result in the individual cross-sectional areas Qi as corner points of the profile cross-section, so that by means of the position coordinates of these corner points in the x- and y-directions, the actual course of the profile longitudinal axis can be detected in the manner described above in at least two rotational positions of the profile 7 and from this the geometric positional deviation of the profile axis from a straight set course can be determined.

1. A method for measuring deviations of a longitudinal axis of a profile from a straight set course, said method comprising:
receiving the profile in a frame;
detecting positional coordinates of contour points of the profile, with a measuring device provided in the frame;
determining in an evaluation device the deviations of an actual course of the longitudinal axis of the profile from the straight set course from the positional coordinates of contour points of cross-sectional areas distributed over a length of the profile, wherein said contour points are offset in angle relative to one another, said determining comprising
first determining a reference line passing through two corresponding contour points located in two of the cross-sectional areas spaced apart from one another,
reference points each in a respective one of a plurality of the cross-sectional areas as points of intersection of the reference line with the respective cross-sectional area,
then recording the positional coordinates of the contour points lying on a common profile generating line in the individual cross-sectional areas in a measuring operation, and then repeating the measuring operation after a rotational adjustment of the profile, which is mounted in two rotationally adjustable receiving devices in a rotationally fixed but torque-free manner, and
determining the deviations from the straight set course of the profile in the evaluation device from the positional coordinates, which are referenced to the reference points, of the contour points detected in at least two rotational positions of the profile.

2. A method according to claim 1, wherein the measuring device has at least one measuring head that is supported so as to be displaced along the profile and that is moved from one of the cross-sectional areas to another of the cross-sectional areas for each of the measuring operations, said measuring head successively detecting the positional coordinates of the contour points in the cross-sectional planes.

3. A method according to claim 1, wherein the profile is rotated by 180° before said repeating of the measuring operation.

4. A method according to claim 1, wherein the measuring operation is repeated three times, and the profile is rotated by 45° between each of the three times that the measuring operation is repeated.

5. A method according to claim 2, wherein the profile is rotated by 180° before said repeating of the measuring operation.

6. A method according to claim 2, wherein the measuring operation is repeated three times, and the profile is rotated by 45° between each of the three times that the measuring operation is repeated.
